(19) United States
(12) Patent Application Publication
(10) Pub. No.: US 2006/0035082 A1
(43) Pub. Date: Feb. 16, 2006

(54) Cemented carbide composite rolls for strip rolling

(75) Inventors: Toshiyuki Hattori, Kitakyushu-shi (JP); Hiroya Tomita, Kitakyushu-shi (JP)

Correspondence Address: SUGHRUE MION, PLLC, 2100 PENNSYLVANIA AVENUE, N.W., SUITE 800, WASHINGTON, DC, 20037, US

(73) Assignee: HITACHI METALS, LTD.

(21) Appl. No.: 10/917,439

(22) Filed: Aug. 13, 2004

(51) Int. Cl. B32B 9/00

(52) U.S. Cl. 428/408

(57) ABSTRACT

A strip-rolling cemented carbide composite roll comprising an inner layer made of steel or iron, and an outer layer of cemented carbide bonded to an outer surface of the inner layer, wherein a thermal shock coefficient R represented by R=σ_{c}(1−ν)/Eα is 400 or more in the outer layer, wherein σ_{c} is a four-point bending strength at room temperature, ν is a Poisson's ratio at room temperature, E is a Young' modulus at room temperature, and α is an average thermal expansion coefficient between room temperature and 800° C.

### FIELD OF THE INVENTION

The present invention relates to a composite roll comprising an inner layer made of steel or iron having excellent toughness and a high-hardness outer layer of cemented carbide, suitable for strip rolling, and a method for evaluating the thermal cracking resistance of such a composite roll.

### BACKGROUND OF THE INVENTION

In order to improve the surface quality of rolled plates and the wear resistance, conventionally cast grain iron rolls and high-speed steel rolls are used for hot rolling, and cast chromium steel rolls and semi-high-speed cast steel rolls for cold rolling. Cemented carbide rolls having much higher wear resistance than those of high-speed steel rolls, etc. were recently developed. Cemented carbide is a sintered alloy comprising tungsten carbide (WC) bonded with metal elements such as Co, Ni, Fe, etc., which may contain carbides of Ti, Ta, Nb, etc. in addition to WC.

For instance, JP 58-39906 B discloses a small sleeve roll for rolling wires, which comprises a steel shaft having excellent toughness is fitted in a sleeve of WC—Co—Ni—Cr cemented carbide at a thermal shrinkage ratio of about 0.1/1000, with the sides of the sleeve mechanically fixed to the shaft by fixing rings, spacer rings, etc. This type of a cemented carbide sleeve roll is relatively short, having an outer diameter of about 100-500 mm and a length of about 10-300 mm.

JP 10-5823 A discloses a composite sleeve comprising an inner sleeve layer of cast steel, an outer sleeve layer of cemented carbide diffusion-bonded to an outer surface of the inner sleeve layer, and a shaft fitted in the inner sleeve layer by shrink fitting, the cemented carbide being a sintered body of mixed powder comprising 60 to 90% by weight of hard particles of at least one of carbides, nitrides and carbonitrides of elements in the Groups IVa-Via of the Periodic Table, the balance being substantially metal powder of at least one of Fe, Ni, Co, Cr, Mo and W, and a surface of the outer sleeve layer being provided with a residual compression stress of 100 MPa or more in a circumferential direction.

JP 10-5824 A discloses a composite roll comprising a cemented carbide outer layer diffusion-bonded to an outer surface of a cast steel shaft, the cemented carbide being a sintered body of mixed powder comprising 60 to 90% by weight of hard particles of at least one of carbides, nitrides and carbonitrides of elements in the Groups IVa-Via of the Periodic Table, the balance being substantially metal powder of at least one of Fe, Ni, Co, Cr, Mo and W, and a surface of the outer layer being provided with a residual compression stress of 100 MPa or more in a circumferential direction.

JP 2002-301506 A discloses a composite roll comprising an inner iron layer, one or more intermediate layers of cemented carbide containing tungsten carbide particles, and an outer layer of cemented carbide containing tungsten carbide particles and metallurgically bonded to the intermediate layer, the amount of tungsten carbide particles in the intermediate layer being smaller than that in the outer layer.

These cemented carbide rolls have much better wear resistance and spalling resistance than those of the conventional cast rolls and forged rolls. Among them, the composite rolls of JP 10-5823 A and JP 10-5824 A are advantageous in that the fixing members used in the assembled cemented carbide roll of JP 58-39906 B are not needed. In addition, because they have outer layers of cemented carbide in the entire length of roll bodies, they are suitable even for the rolling of strips.

During rolling a strip, a so-called mill stoppage accident, by which a mill stops while biting a rolled plate, and a so-called squeeze accident, by which a rolled strip is bitten between rolls in a folded state, may happen. Once such rolling accidents happen, a large thermomechanical load is likely to be applied to a roll surface, resulting in deep cracks on outer layer surfaces of the rolls. Cracks are likely to propagate deep into the outer layers of the rolls by a repeated thermomechanical load in subsequent rolling, resulting in breakage of the rolls. An important characteristic of the roll is that such accident never happens.

Cemented carbide rolls suffer from little seizure of steel strips because of high percentages of carbides such as WC, etc., and only a small amount of heat enters thereinto through roll surfaces. In addition, they have small thermal expansion coefficients. Accordingly, they undergo smaller thermal shock than conventional iron-based alloy rolls. However, because the cemented carbide rolls are likelier to suffer from cracks due to their high hardness, and generated cracks extremely easily propagate, resulting in the breakage of rolls and the peeling of outer layers in worst cases.

In addition, there has been no parameter for evaluating thermal crack resistance of the cemented carbide rolls. For instance, the mechanical strength of the cemented carbide roll does not necessarily have direct correlation with thermal crack resistance, and even cemented carbide rolls having high mechanical strength may be subjected to cracking due to thermal shock. Thus, the precise evaluation of the thermal crack resistance of the cemented carbide roll has not practically been conducted.

### OBJECT OF THE INVENTION

Accordingly, an object of the present invention is to provide a cemented carbide composite rolls for strip rolling having excellent wear resistance and spalling resistance and resistant to accidents such as thermal cracking, breakage, etc.

Another object of the present invention is to provide a method for evaluating the thermal cracking resistance of a cemented carbide composite roll for strip rolling precisely and easily.

### DISCLOSURE OF THE INVENTION

As a result a heat shock test conducted on a cemented carbide composite roll, taking into consideration that thermal shock cracking occurs when a material has insufficient strength relative to a thermal stress generated, it has been found that when the composite roll has a thermal shock coefficient R[=σ_{c}(1−ν)/Eα] of 400 or more, the generation of thermal shock cracks is effectively prevented. The present invention has been completed based on such finding.

Thus, the strip-rolling cemented carbide composite roll of the present invention comprises an inner layer made of steel or iron, and an outer layer of cemented carbide bonded to an outer surface of the inner layer, wherein a thermal shock coefficient R represented by R=σ_{c}(1−ν)/Eα is 400 or more in the outer layer, wherein σ_{c} is a four-point bending strength at room temperature, ν is a Poisson's ratio at room temperature, E is a Young' modulus at room temperature, and α is an average thermal expansion coefficient between room temperature and 800° C.

A preferred example of the cemented carbide composite roll of the present invention is a sleeve roll comprising a hollow cylindrical inner layer made of steel or iron, and an outer layer of cemented carbide bonded to an outer surface of the inner layer. In this sleeve roll, a ratio of the cross-sectional area of the inner layer to the cross-sectional area of the entire roll is preferably 0.5 or more in the cross section of the roll perpendicular to its longitudinal axis.

The surface of the outer layer is preferably provided with an in-plane residual compressive stress. At least one intermediate layer is provided between the outer layer and the inner layer. The intermediate layer is preferably made of cermet.

The method for evaluating the thermal cracking resistance of a strip-rolling cemented carbide composite roll comprising an inner layer made of steel or iron, and an outer layer of cemented carbide bonded to an outer surface of the inner layer, comprises the steps of (1) measuring a four-point bending strength σ_{c} at room temperature, a Poisson's ratio ν at room temperature, a Young' modulus E at room temperature, and an average thermal expansion coefficient α between room temperature and 800° C. in the outer layer; (2) calculating a thermal shock coefficient R represented by the formula of R=σ_{c}(1−ν)/Eα; and (3) determining that the composite roll has enough thermal cracking resistance when the thermal shock coefficient R is 400 or more.

### BRIEF DESCRIPTION OF THE DRAWINGS

FIG. 1(a) is a cross-sectional view showing a roll body portion of the cemented carbide composite roll according to the first embodiment of the present invention;

FIG. 1(b) is a cross-sectional view showing a roll body portion of the cemented carbide composite roll according to the second embodiment of the present invention;

FIG. 1(c) is a cross-sectional view showing a roll body portion of the cemented carbide composite roll according to the third embodiment of the present invention; and

FIG. 1(d) is a cross-sectional view showing a roll body portion of the cemented carbide composite roll according to the fourth embodiment of the present invention.

### DETAILED DESCRIPTION OF THE PREFERRED EMBODIMENTS

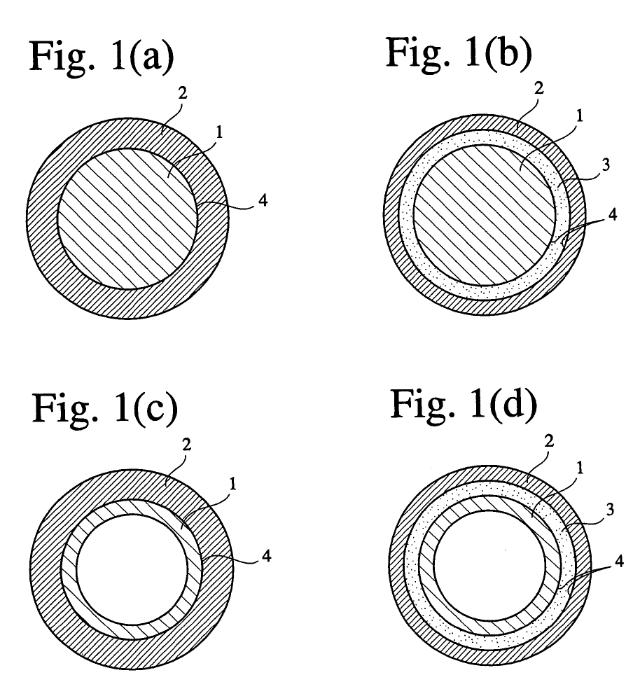

The cemented carbide composite roll of the present invention may be a solid composite roll, or an assembled composite roll comprising a shaft fitted in a composite sleeve roll by shrink fitting. FIGS. 1(a) to (d) show roll body portions of various cemented carbide composite rolls of the present invention. FIG. 1(a) shows a solid composite roll comprising an inner layer (shaft) 1 made of steel or iron, and an outer layer 2 of cemented carbide bonded to the inner layer 1. FIG. 1(b) shows a solid cemented carbide composite roll comprising an inner layer 1 bonded to an outer layer 2 of cemented carbide via an intermediate layer 3. FIG. 1(c) shows a hollow cemented carbide composite sleeve roll comprising a hollow inner layer 1 bonded to an outer layer 2 of cemented carbide. FIG. 1(d) shows a hollow cemented carbide composite sleeve roll comprising a hollow inner layer 1 bonded to an outer layer 2 of cemented carbide via an intermediate layer 3. In each figure, 4 represents a bonding interface.

In any embodiment, the outer layer 2 has a thermal shock coefficient R[=σ_{c}(1−ν)/Eα] of 400 or more. The thermal shock coefficient R is determined from a four-point bending strength σ_{c} (MPa) at room temperature, an average thermal expansion coefficient α (° C.⁻¹) between room temperature and 800° C., a Poisson's ratio ν at room temperature, and a Young' modulus E (MPa) at room temperature, each measured on a cemented carbide test piece cut out of the outer layer 2.

The fact that the outer layer 2 of cemented carbide has a large thermal shock coefficient R means that it has a large cracking resistance to rapid temperature change (thermal cracking resistance). The thermal shock coefficient R is preferably 500 or more, more preferably 600 or more.

To reduce thermal stress, the surface of the outer layer of the cemented carbide composite roll is preferably provided with a residual compressive stress in advance. The in-plane residual compression stress on the surface of the outer layer hinders the generated heat cracks from propagating. The residual compression stress is preferably 100-500 MPa.

The residual compressive stress on the surface of the cemented carbide composite roll (particularly composite sleeve roll) is generated by the difference in strain between the outer layer and the inner layer, and its value increases as a ratio of the cross-sectional area of the inner layer to the cross-sectional area of the entire roll (inner layer/outer layer cross section ratio) in a cross section perpendicular to the longitudinal axis of the roll increases. Accordingly, to give a large residual compression stress to the roll surface, the inner layer/outer layer cross section ratio is preferably set at a predetermined value or more. Investigation on various designs has revealed that the inner layer/outer layer cross-section ratio of 0.5 or more would be able to give a sufficiently large residual compression stress to the roll surface. The inner layer/outer layer cross-section ratio is more preferably 0.55 or more, most preferably 0.6 or more.

At least one intermediate layer of cermet such as cemented carbide or a metal is preferably formed between the outer layer of cemented carbide and the inner layer made of steel or iron to increase bonding strength between the outer layer and the inner layer. Among them, at least an intermediate layer adjacent to the outer layer of cemented carbide is preferably a cermet such as cemented carbide comprising 30% by mass or more of a metal binder. To increase the bonding strength between the outer layer and the inner layer sufficiently, the thickness of the intermediate layer (total thickness in the case of two layers or more) is preferably 1 mm or more.

The production method of the composite roll of the present invention comprises causing the metallurgical (diffusion) bonding of the outer layer of cemented carbide to the inner layer made of steel or iron by a vacuum-sintering method, a high-pressure sintering method or a hot-isostatic pressing (HIP) method.

To evaluate the thermal cracking resistance of the resultant composite roll, (1) the outer layer is measured with respect to a four-point bending strength σ_{c} at room temperature, a Poisson's ratio ν at room temperature, a Young' modulus E at room temperature, and an average thermal expansion coefficient α between room temperature and 800° C.; (2) a thermal shock coefficient R represented by the formula of R=σ_{c}(1−ν)/Eα is calculated; and (3) it is determined that the composite roll has enough thermal cracking resistance, when the thermal shock coefficient R is 400 or more.

The present invention will be explained in more detail by Examples below, without intention of restricting the present invention thereto.

### EXAMPLE 1

80% by mass of WC powder having an average particle size of 5 μm and 20% by mass of Co powder having an average particle size of 1 μm were mixed with alcohol for 20 hours in a ball mill, and dried to form a starting material powder of cemented carbide for the outer layer.

Produced using the above starting material powder of cemented carbide for the outer layer was a hollow sleeve (outer layer) of semi-sintered cemented carbide having an outer diameter of 700 mm, an inner diameter of 655 mm and a length of 2000 mm. A dispersion of the above starting material powder of cermet for the intermediate layer in alcohol was applied with a brush to an outer surface of a hollow cylindrical inner layer made of steel (SCM440) having an outer diameter of 650 mm, an inner diameter of 500 mm and a length of 2000 mm, and dried to form an intermediate layer. This inner layer was placed in a can for HIP having an inner diameter 700 mm and a length of 2000 mm in a center thereof, and the above semi-sintered hollow sleeve was placed outside the inner layer.

Steel lids were welded to the both ends of the can for HIP, and the can was sealed after evacuation at 700° C. After confirming that there was no leak in the can for HIP, a HIP treatment was conducted at 1300° C. and 1000 atom. After cooling, the can was removed by machining, and it was confirmed by an ultrasonic flaw-detecting method that the outer layer, the intermediate layer and the inner layer were well bonded. Thus obtained was a strip-rolling cemented carbide composite sleeve, in which a ratio of the cross-sectional area of the inner layer to the cross-sectional area of the entire sleeve roll was 0.75 in a cross section perpendicular to the longitudinal axis.

Test pieces cut out of the outer layer of this composite sleeve were measured with respect to a four-point bending strength σ_{c} at room temperature, an average thermal expansion coefficient a between room temperature and 800° C., a Poisson's ratio ν at room temperature and a Young' modulus E at room temperature according to JIS R 1601, and a thermal shock coefficient R[=σ_{c}(1−ν)/Eα] was calculated from these data. With a strain gauge attached to a longitudinal center portion of the outer layer, an in-plane residual compression stress on the surface of the outer layer was measured by destructive method. Further, a test piece cut out of the composite sleeve in a diametric direction such that it included the inner layer, the intermediate layer and the outer layer was measured with respect to bending strength according to JIS R1601. The results are shown in Table 1.

### EXAMPLE 2

80% by mass of WC powder having an average particle size of 10 μm and 20% by mass of Co powder having an average particle size of 1 μm were mixed with alcohol for 10 hours in a ball mill, and then dried to form a starting material powder of cemented carbide for the outer layer.

A hollow cylindrical inner layer of forged steel having an outer diameter of 650 mm, an inner diameter of 500 mm and a length of 2000 mm was placed in a steel can for HIP having an inner diameter of 710 mm and a length of 2000 mm, and a steel pipe partition having an inner diameter of 510 mm and a thickness of 2 mm was placed around the inner layer.

The above starting material powder of cemented carbide for the outer layer was charged between the inner surface of the can for HIP and the partition. Also, the above cermet powder for the intermediate layer was charged between the partition and the inner layer. The partition was then withdrawn, and a steel lid was welded on both ends of the can. The can was sealed after evacuation at 700° C. After confirming that there was no leak in the can for HIP, a HIP treatment was conducted at 1300° C. and 1000 atom. After cooling, the can was removed by machining. Thus obtained was a cemented carbide composite sleeve having an inner layer/outer layer cross-section ratio of 0.75.

This composite sleeve was measured with respect to a four-point bending strength σ_{c} at room temperature, an average thermal expansion coefficient α between room temperature and 800° C., a Poisson's ratio ν at room temperature and a Young' modulus E at room temperature according to JIS R 1601, and a thermal shock coefficient R[=σ_{c}(1−ν)/Eα] was calculated from these data, both in the same manner as in Example 1. Also, the in-plane residual compression stress on the surface of the outer layer and the bending strength of a test piece including the inner layer, the intermediate layer and the outer layer were measured. The results are shown in Table 1.

### EXAMPLE 3

70% by mass of WC powder having an average particle size of 5 μm and 30% by mass of Co powder having an average particle size of 1 μm were mixed with alcohol for 5 hours in an attritor, and then dried to form a starting material powder of cemented carbide for the outer layer. Using this starting material powder of cemented carbide for the outer layer, a green body for a hollow sleeve (outer layer) having an outer diameter of 300 mm, an inner diameter of 200 mm and a length of 1000 mm was produced. This hollow sleeve was placed outside an inner layer constituted by a solid steel rod (SCM440) having an outer diameter of 180 mm and a length of 1000 mm.

The resultant composite body was subjected to vacuum sintering at 1350° C. The ultrasonic flaw detection of the resultant composite roll revealed that the outer layer and the inner layer were well bonded. Thus obtained was a cemented carbide composite roll, in which a ratio of the cross-sectional area of the inner layer to the cross-sectional area of the entire roll was 0.8 in a cross section perpendicular to the longitudinal axis of the roll.

This composite sleeve was measured with respect to a four-point bending strength σ_{c}, at room temperature, an average thermal expansion coefficient a between room temperature and 800° C., a Poisson's ratio ν at room temperature and a Young' modulus E at room temperature according to JIS R 1601, and a thermal shock coefficient R[=σ_{c}(1−ν)/Eα] was calculated from these data, both in the same manner as in Example 1. Also, the in-plane residual compression stress on the surface of the outer layer and the bending strength of a test piece including the inner layer, the intermediate layer and the outer layer were measured. The results are shown in Table 1.

TABLE 1

| | σ_{c}⁽¹⁾ | α⁽²⁾ | | E⁽⁴⁾ | | RCS⁽⁶⁾ | BS⁽⁷⁾ |
|---|---|---|---|---|---|---|---|
| No. | (MPa) | (° C.⁻¹) | N⁽³⁾ | (MPa) | R⁽⁵⁾ | (MPa) | (MPa) |
| Example 1 | 2000 | 6.5 × 10⁻⁶ | 0.22 | 5.0 × 10⁵ | 480 | −402 | 1630 |
| Example 2 | 2000 | 6.2 × 10⁻⁶ | 0.22 | 5.2 × 10⁵ | 484 | −412 | 1780 |
| Example 3 | 2000 | 8.0 × 10⁻⁶ | 0.22 | 4.3 × 10⁵ | 453 | −650 | 1230 |

Note
⁽¹⁾Four-point bending strength at room temperature.
⁽²⁾Average thermal expansion coefficient between room temperature and 800° C.
⁽³⁾Poisson's ratio at room temperature.
⁽⁴⁾Young' modulus at room temperature.
⁽⁵⁾Thermal shock coefficient [= σ_{c} (1 − ν)/Eα].
⁽⁶⁾In-plane residual compression stress on the surface of the outer layer.
⁽⁷⁾Bending strength of a test piece cut out of the composite sleeve in a diametric direction such that it included an inner layer (an intermediate layer, if any) and an outer layer.

As is clear from Table 1, any of the cemented carbide composite rolls of Examples 1-3 had a thermal shock coefficient R of 400 or more, and sufficient bending strength.

A shaft of chromium-molybdenum steel was fitted in each cemented carbide composite sleeve of Examples 1 and 2 by shrink fitting, and the resultant composite body was machined to a predetermined size to provide a cemented carbide composite roll. Each cemented carbide composite roll of Examples 1-2 was used to roll a steel strip of 2 mm thick and 800 mm wide in a finishing stand of a hot strip mill. The observation of the roll surface after rolling revealed that the roll retained an extremely smooth surface, indicating that it had excellent wear resistance and spalling resistance. Also, few heat cracks were generated on the roll surface, and the propagation of cracks was limited.

Because the strip-rolling cemented carbide composite roll of the present invention comprises an outer layer of cemented carbide having a thermal shock coefficient R of 400 or more, it is excellent in wear resistance and spalling resistance, with suppressed generation of thermal shock cracks. In addition, the presence of a residual compressive stress in the outer layer prevents the generation of initial cracks and their propagation.

1. A strip-rolling cemented carbide composite roll comprising an inner layer made of steel or iron, and an outer layer of cemented carbide bonded to an outer surface of said inner layer, wherein a thermal shock coefficient R represented by R=σ_{c}(1−ν)/Eα is 400 or more in said outer layer, wherein σ_{c} is a four-point bending strength at room temperature, ν is a Poisson's ratio at room temperature, E is a Yong's modulus at room temperature, and α is an average thermal expansion coefficient between room temperature and 800° C.

2. The strip-rolling cemented carbide composite roll according to claim 1, wherein it has a sleeve roll structure comprising an outer layer of cemented carbide bonded to a hollow cylindrical inner layer made of steel or iron; wherein a ratio of the cross-sectional area of said inner layer to the cross-sectional area of the entire roll is 0.5 or more in the cross section of said roll perpendicular to its longitudinal axis.

3. The strip-rolling cemented carbide composite roll according to claim 1, wherein said surface of the outer layer has an in-plane residual compressive stress.

4. The strip-rolling cemented carbide composite roll according to any one of claim 1, wherein it further comprises at least one intermediate layer between said outer layer and said inner layer.

5. The strip-rolling cemented carbide composite roll according to claim 4, wherein said intermediate layer is made of cermet.

6. A method for evaluating the thermal cracking resistance of a strip-rolling cemented carbide composite roll comprising an inner layer made of steel or iron, and an outer layer of cemented carbide bonded to an outer surface of said inner layer, comprising the steps of (1) measuring a four-point bending strength σ_{c} at room temperature, a Poisson's ratio ν at room temperature, a Yong's modulus E at room temperature, and an average thermal expansion coefficient α between room temperature and 800° C. in said outer layer; (2) calculating a thermal shock coefficient R represented by the formula of R=σ_{c}(1−ν)/Eα; and (3) determining that said composite roll has enough thermal cracking resistance when the thermal shock coefficient R is 400 or more.

7. The strip-rolling cemented carbide composite roll according to claim 2, wherein said surface of the outer layer has an in-plane residual compressive stress.

8. The strip-rolling cemented carbide composite roll according to claim 2, wherein it further comprises at least one intermediate layer between said outer layer and said inner layer.

9. The strip-rolling cemented carbide composite roll according to claim 3, wherein it further comprises at least one intermediate layer between said outer layer and said inner layer.
